(19) United States
(12) Patent Application Publication
(10) Pub. No.: US 2015/0131693 A1
(43) Pub. Date: May 14, 2015

(54) LASER FORMING PROCESS

(71) Applicant: Symphony Acoustics, Inc., Parker, TX (US)

(72) Inventor: Dustin Wade Carr, Marietta, NM (US)

(21) Appl. No.: 14/597,154

(22) Filed: Jan. 14, 2015

Related U.S. Application Data
(60) Provisional application No. 61/904,357, filed on Nov. 14, 2013.

(51) Int. Cl. H01S 3/08; B23K 26/00

(52) U.S. Cl. CPC H01S 3/08; B23K 26/0081
USPC 372/107; 219/121.66

(57) ABSTRACT

A method for controlling the parallelism of first and second surfaces that define an optically resonant cavity is disclosed. The surfaces are separated by a first separation that is based on a support that holds the first surface relative to the second surface. The support comprises a first material and includes one or more regions in which the material stress of the first material is heat tuned to locally induce a stress gradient that results in a localized deformation. By controlling the locations and amounts of one or more localized deformation regions, the orientation of the first surface relative to the second surface is controlled.

### RELATED APPLICATIONS

This application claims the benefit of U.S. Provisional Application No. 61/904,357 filed Nov. 14, 2013 (Attorney Docket: 123-190PR1). The entire disclosure of U.S. Provisional Application No. 61/904,357 is incorporated herein by reference.

### FIELD OF THE INVENTION

The present invention relates to device fabrication in general, and, more particularly, to laser forming techniques for physical tuning of a mechanical assembly.

### BACKGROUND OF THE INVENTION

An optically resonant cavity is an optical element comprising two partially reflective surfaces that are separated by a substantially uniform distance, referred to as the cavity length. Light incident on the optically resonant cavity is reflected by or transmitted through the cavity based a relationship between the cavity length and the wavelength of the signal. For example, transmission through the cavity is a maximum for a cavity length that is an integer multiple of one-half of the wavelength of a light signal, while reflection by the cavity is maximized when the cavity length is an odd multiple of one-quarter of the wavelength of a light signal. Between these maximum conditions, light is partially reflected and partially transmitted, where the ratio of reflection/transmission varies as a function of the wavelength/cavity length ratio.

In order to achieve good performance, it is critical that the two partially reflective surfaces are arranged with a high degree of parallelism. For many applications a parallelism of at least 10⁻⁴ radians is necessary. Unfortunately, for optically resonant cavities formed of multiple structural elements and/or materials, it can be difficult, if not impossible to achieve such a high degree of parallelism during assembly.

### SUMMARY OF THE INVENTION

The present invention enables formation of a high-performance optically resonant cavity without some of the costs and disadvantages of the prior art. Embodiments of the present invention are particularly well suited for use in displacement sensors, accelerometers, gravimeters, shock sensors, and the like.

An illustrative embodiment of the present invention is a method for assembling an optically resonant cavity comprising a pair of partially transmissive mirrors such that the mirrors are characterized by a high degree of parallelism. In some embodiments, the mirrors are assembled such that they are parallel to better than 10⁻⁴ radians.

An illustrative embodiment of the present invention is a method for assembling an optically resonant cavity having one surface that is movable in response to an environmental stimulus. Once the components parts of the cavity are assembled and fixed, regions of the cavity assembly are exposed to a pulsed laser signal. The exposed regions are locally heated by absorption of the pulsed laser light such that the temperature of the material in these regions reaches its melting point and melts (or undergoes other change in the phase or morphology that result in a change of material stress). The heated regions are then allowed to cool to induce a change in the stress-relaxation temperature of their material. As a result, the heat-treated regions have a stress-relaxation temperature that differs from other portions of the cavity assembly, which gives rise to controlled, localized deformation.

Feedback regarding the parallelism of the cavity surfaces is obtained by directing a dynamic interrogation laser signal at the optically resonant cavity and detecting light of this signal reflected from the front and back surfaces of the cavity. When the surfaces are perfectly parallel, the spots from each of the surfaces are perfectly aligned. Slight non-parallelism of the surfaces, however, results in detection of two spots reflected from the cavity. When the cavity surfaces are only slightly non-parallel, these spots are close enough to one another that interference between them occurs. This interference gives rise to modulation of the dynamic signal. The depth of this modulation is used as a figure of merit for the parallelism of the cavity surfaces.

In some embodiments, the cavity is interrogated by a swept-wavelength laser signal and the reflected intensity is measured as a function of wavelength. In such embodiments, the depth of modulation as the wavelength is swept serves as the figure of merit for the parallelism. Further, cavity length can be precisely tuned by measuring the wavelengths of the peaks of the reflected signal.

The illustrative method includes sequentially heating a region, allowing it to cool, and evaluating the resultant parallelism of the surfaces by determining the modulation depth. This sequence of operations is repeated until the depth of modulation reaches a user-defined endpoint, thereby indicating that a desired state of parallelism has been attained.

By carefully controlling the location, amount of stress-altered material, and/or the size of the heat-treated regions, slight changes can be induced in the assembly thereby enabling the parallelism of the partially reflective surfaces to be tuned.

An embodiment of the present invention is an optically resonant cavity comprising: a first surface; a second surface; and a support comprising a first material, the support being operative for separating the first surface and second surface by a first separation, wherein the support includes a first region in which the first material is characterized by a first material stress and a second region in which the first material is characterized by a second material stress; wherein the first separation is characterized by a first parallelism that is based on a difference between the first material stress and the second material stress.

### BRIEF DESCRIPTION OF THE DRAWINGS

FIGS. 1A and 1B depict schematic drawings of top and cross-sectional views, respectively, of displacement sensor comprising an optically resonant cavity in accordance with an illustrative embodiment of the present invention.

FIG. 2 depicts a plot of the reflectance of a representative Fabry-Perot cavity with respect to cavity length and wavelength.

FIG. 3 depicts a block diagram for a laser-forming system in accordance with the present invention.

FIG. 4 depicts operations of a method suitable for tuning an optically resonant cavity in accordance with the illustrative embodiment of the present invention.

FIG. 5 depicts sub-operations suitable for use in operation 406 in accordance with the illustrative embodiment.

FIG. 6 depicts a representative plot of the power of laser signal 324 versus voltage applied to variable retarder 318.

### DETAILED DESCRIPTION

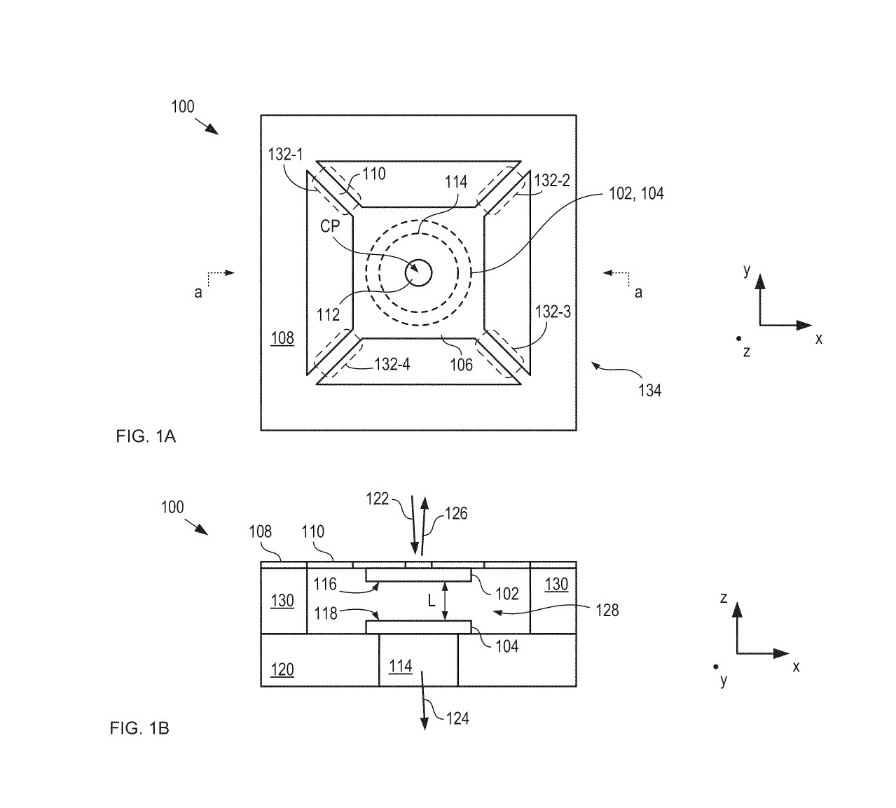

FIGS. 1A and 1B depict schematic drawings of top and cross-sectional views, respectively, of displacement sensor comprising an optically resonant cavity in accordance with an illustrative embodiment of the present invention. FIG. 1B depicts a cross-sectional view of sensor 100 through line a-a, as shown in FIG. 1A. Sensor 100 includes mirrors 102 and 104, plate 106, and support 134.

Mirrors 102 and 104 are partially transmissive mirrors for the wavelengths included in input light signal 122. Mirror 102 is affixed to plate 106. Mirror 104 is affixed to conventional substrate 120. Typically, the mirrors are joined to plate 106 and substrate 120 using an adhesive.

Mirrors 102 and 104 include surfaces 116 and 118, respectively, which collectively define optically resonant cavity 128.

Mirror 102 is affixed to plate 106, which is held above substrate 120 by support 134. Support 134 includes suspended from frame 108 by tethers 110. Tethers 110 enable motion of plate 106 and, therefore mirror 102, in the z-direction in response to an acceleration of displacement sensor 100.

Optically resonant cavity 128 has cavity length, L, whose quiescent value is determined by the thickness of stand-offs 130.

In operation, input light signal 122 interrogates cavity 128 through access hole 112, which is formed in plate 106. Input light signal 122 is distributed into transmitted signal 124 and reflected signal 126 based on the wavelength of input light signal 122 and cavity length L.

It should be noted that the design of sensor 100 described herein is merely exemplary and that myriad alternative sensor designs, as well as constituent sensor elements (e.g., tethers 110, etc.), are within the scope of the present invention.

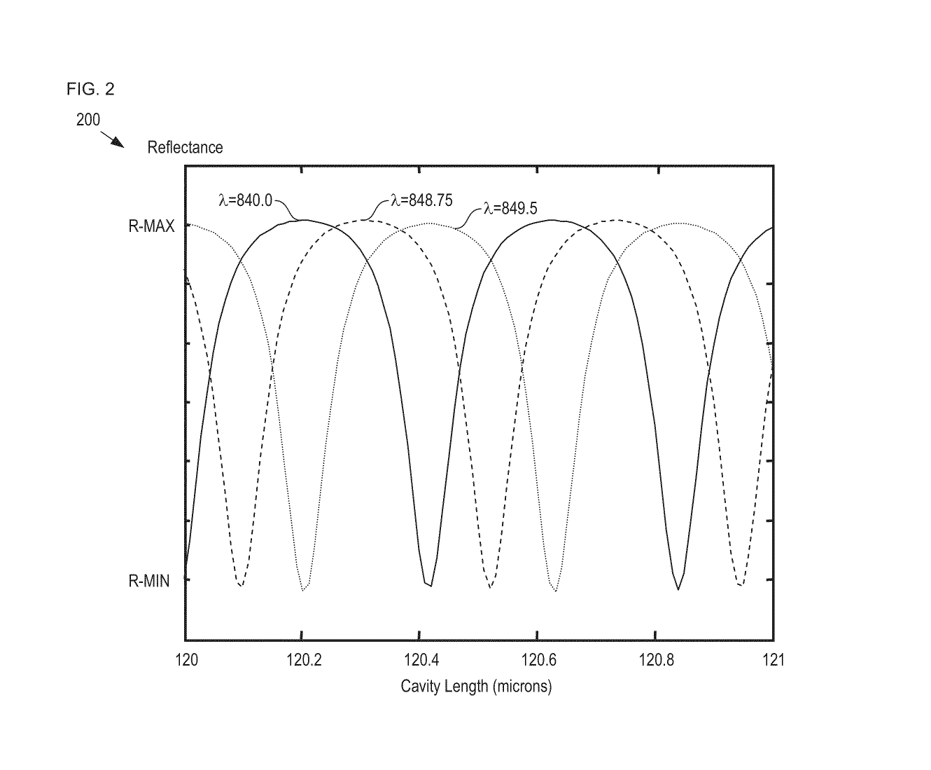

FIG. 2 depicts a plot of the reflectance of a representative Fabry-Perot cavity with respect to cavity length and wavelength. The intensity of reflected signal 126 is plotted for three different wavelengths, λ=848 nm, λ=848.75 nm, and λ=849.5 nm for a cavity length range from 120 microns to 121 microns. As can be seen from these plots, a change of cavity length L by approximately 200 nm is equivalent to a wavelength shift of only 1.5 nm for input light signal 122. One skilled in the art will recognize that the intensity of transmitted signal 124 is substantially the inverse of that of reflected signal 126.

Ideally, stand-offs 130 are of identical height and displacement sensor is assembled such that surfaces 116 and 118 are perfectly parallel. In practice, however, some difference in the height of stand-offs 130 is typical. Further, sensor 100 includes multiple component parts, as well as different materials, which are joined together during assembly of the sensor. As a result, the variations during the assembly process leads to a tolerance stickup that can result in surfaces 116 and 118 being non-parallel to a degree that is out of a required specification. This gives rise to a reflectivity of cavity 128 that is non-uniform and the performance of displacement sensor 100 is ultimately degraded.

It is an aspect of the present invention that an optically resonant cavity can be tuned, after assembly, to improve the parallelism of its partially reflective surfaces.

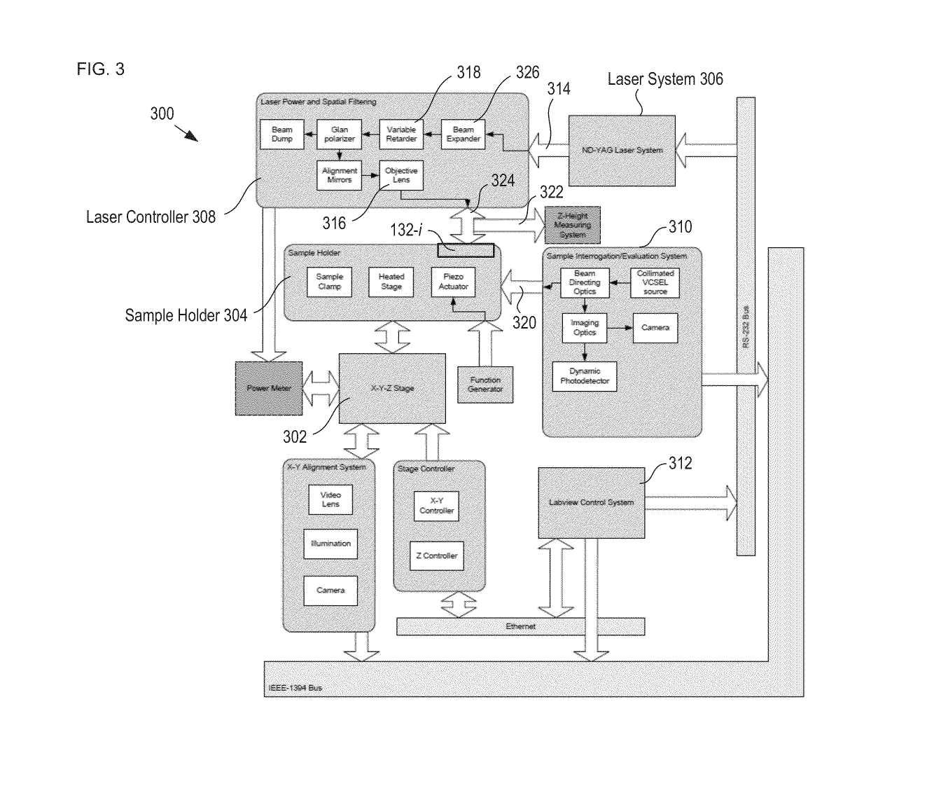

FIG. 3 depicts a block diagram for a laser-forming system in accordance with the present invention. System 300 comprises translation stage 302, sample holder 304, laser system 306, laser controller 308, interrogation system 310, and measurement control system 312.

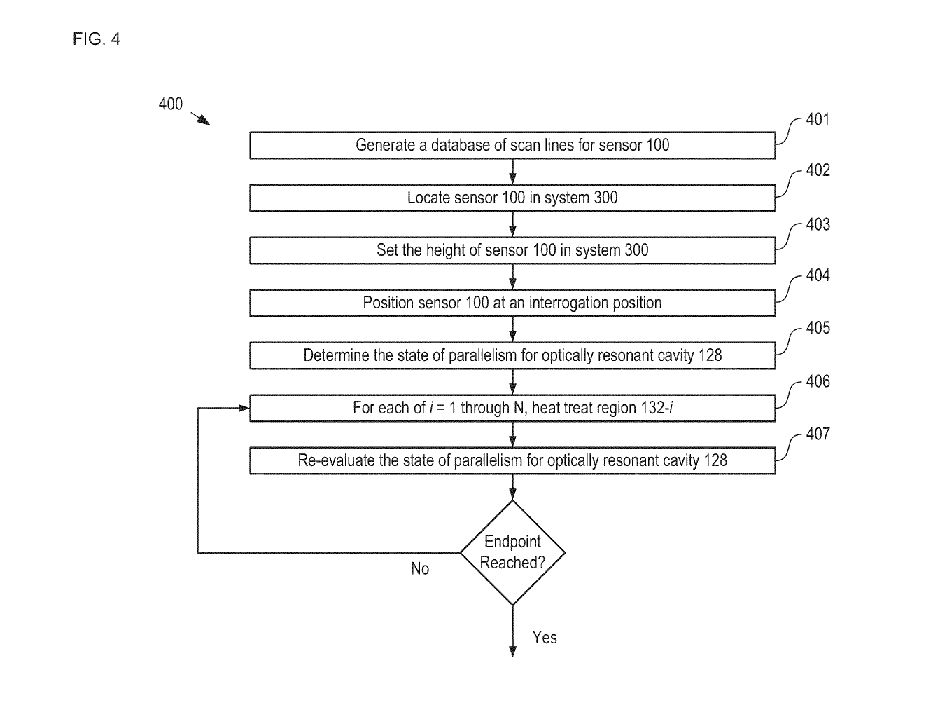

FIG. 4 depicts operations of a method suitable for tuning an optically resonant cavity in accordance with the illustrative embodiment of the present invention. Method 400 begins with operation 401, wherein a database of N scan lines is generated for sensor 100, where each scan line corresponds to a different region to be heat treated in order to change the stress of its constituent material and N is the total number of scan lines determined. Method 400 is described with continuing reference to FIGS. 1A-B and 3.

In some embodiments, the database of scan lines is determined, for example, through inspection of the design of the mechanical structure of sensor 100 and determination of those positions on its structure that will generate the most deflection per scan. One skilled in the art will recognize, after reading this Specification, that the number and position of scan lines 132 is a matter of design and can be any practical value.

At operation 402, sensor 100 is loaded into sample holder 304. During operation 402, sensor 100 is located within system 300 such that regions 132-1 through 132-4 (referred to, collectively, as regions 132) are aligned with the desired scan lines for sensor 100.

At operation 403, translation stage 304 positions sensor 100 to enable interrogation system 310 to set a proper height for the sensor. The height of the sensor is established based on an optimal position for interrogation system 310 using, for example, an autofocus algorithm.

At operation 404, translation stage 304 positions sensor 100 at an interrogation position in which interrogation system 310 can interrogate optically resonant cavity 128.

At operation 405, optical cavity 128 is interrogated by interrogation system 310 to determine its initial state. Interrogation system 310 directs measurement signal 320 onto optical cavity 128 and receives reflected signal 322. Normally, reflected signal 322 includes a first portion reflected from surface 116 and a second portion reflected from surface 118. These two reflected portions generate two laser spots at the imaging optics, which evaluates the image produced by the reflected beams and provides a measure of the total signal power that is reflected.

Typically, ambient noise or building vibration is sufficient to induce a physical response in sensor 100, which manifests as motion between surfaces 116 and 118. As a result, the cavity length of sensor 100 is not fixed, but instead includes a dynamic component that results in reflected signal 322 being a dynamic signal. In some embodiments, the sensor is proactively actuated (e.g., by delivery of mechanical energy, such as vibration, shock, sound energy, etc.) to make reflected signal 322 dynamic. In some embodiments, the sensor is driven into resonance by the applied energy. In some embodiments, measurements signal 320 is a swept-wavelength signal thereby giving rise to a dynamic reflected signal 322. It should be noted that, due to the dynamic component of reflected signal 322, the total signal power reflected by optically resonant cavity 128 must be detected with sufficient bandwidth (e.g., at least 5 KHz) to enable observation of the resonances of sensor 100.

When the two laser spots from the reflected portions are perfectly aligned, surfaces 116 and 118 are perfectly parallel. When the spots are nearly, but not perfectly aligned, however, interference between the reflected signal portions occurs, which gives rise to a modulation of dynamic reflected signal 322. It should be noted that when the spots are very closely aligned, their relative positions on the camera display no longer provide a reliable indicator of parallelism; however, the depth of modulation in dynamic reflected signal 322 increases. It is an aspect of the present invention that the depth of modulation in reflected signal 322 can he used as a figure of merit for the parallelism of surfaces 116 and 118.

At operation 406, for each of i=1 through N, region 132-i is heat treated to improve the alignment of the spots reflected from surfaces 116 and 118.

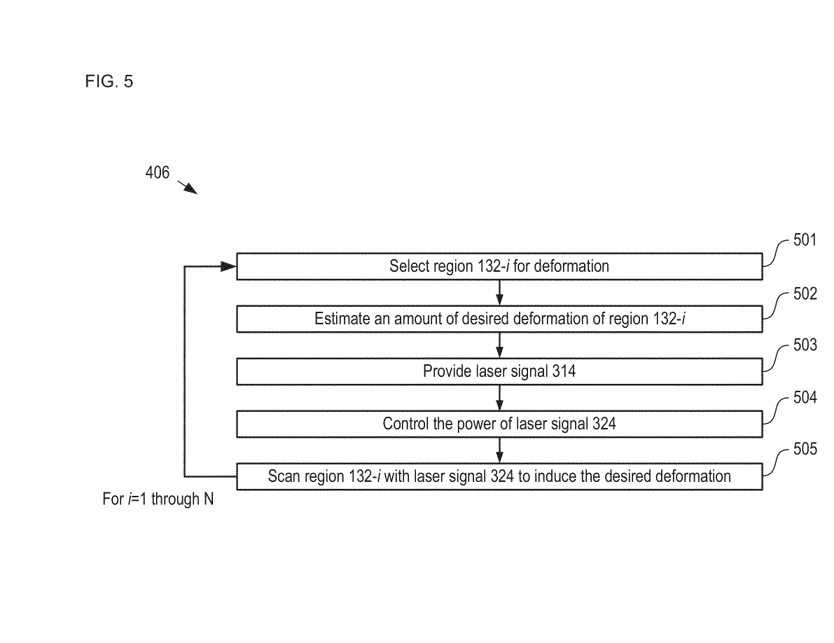

FIG. 5 depicts sub-operations suitable for use in operation 406 in accordance with the illustrative embodiment. Operation 406 begins with sub-operation 501, wherein region 132-i is selected for deformation based on a desired change in the parallelism of surfaces 116 and 118 along a given direction. In other words, the region selected for deformation is selected to move one of the reflected spots in a desired direction. For example, by changing the material stress in both of regions 132-1 and 132-4 relative to the material stress in regions 132-2 and 132-3, the parallelism of surfaces 116 and 118 along the x-direction (as shown in FIG. 1) can be altered. In similar fashion, by changing the material stress in both of regions 132-1 and 132-2 relative to the material stress in regions 132-3 and 132-4, the parallelism of surfaces 116 and 118 along the y-direction can be affected.

At sub-operation 502, an estimate of the distance that the spot is to be moved based on deformation of region 132-i is computed.

At sub-operation 503, laser signal 314 is directed to region 132-i.

Laser system 306 is a ND-YAG diode pumped laser system that is typically operated in a constant current mode (e.g., at a setting of 45.89). Laser signal 314 is a train of laser pulses having constant power and constant repetition rate (e.g., 3 KHz), It should be noted that, the maximum power and total energy in each pulse is a nonlinear function of the repetition rate and laser current. As a result, once a desired power setting and pulse rate are established, it is preferable that they remain constant to avoid deleterious effects on pulse shape.

At sub-operation 504, laser controller 308 controls the power of laser signal 324 directed at region 132-i. The power of laser signal 324 is controlled at the output of objective lens 316 by controlling the voltage applied to variable retarder 318. In order to avoid damage to variable retarder 318, as well as other optical components in system 100, laser controller includes optional beam expander 326.

Laser controller 308 also includes alignment mirrors 328, which direct laser signal 314 at a precisely perpendicular angle, centered on the back aperture of objective lens 316, which focuses laser signal 324 onto the part to be formed. Typically, laser signal 324 is focused to a spot having a diameter of order 10 microns.

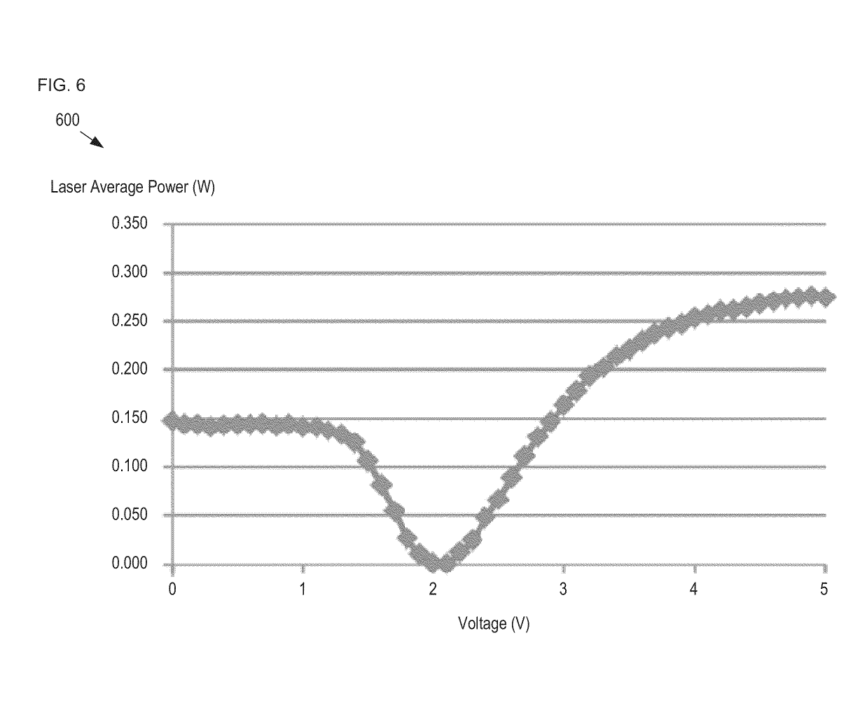

FIG. 6 depicts a representative plot of the power of laser signal 324 versus voltage applied to variable retarder 318. Plot 600 shows that a substantially linear range exists for applied voltages within the range of approximately 2.1 V to approximately 2.4 V. This range, therefore, represents an attractive operation range for system 300.

At sub-operation 505, region 132-i is scanned under objective lens 316 by translation stage 304 such that each point in the region is heated as desired by absorption of the energy of the laser light in laser signal 324. As region 132-i is scanned under objective lens 316, the laser signal locally heats the surface on which it is incident, thereby heating the surface material to the point of melting. After heating, as the material cools, its stress relaxation temperature is changed relative to the rest of the material of the region. This gives rise to a stress gradient in the material, which then results in local deformation. In some embodiments, laser signal 324 is tightly focused and well controlled, which enables sub-nanometer control over the amount of deformation induced.

In some embodiments, sub-operation 505 is repeated a number of times (e.g., ten times or more). The number of repeated scans of region 132-i is based on an estimate of how far the moving spot be translated.

In some embodiments, the voltage applied to variable retarder 318 is changed to reduce the power of laser signal 324 as the scan of region 132-i reaches the end of the region. This offers finer control over the induced deformation. In some embodiments, the rate at which translation stage 304 scans region 132-i under objective lens 316 is adjusted to enable, for example the formation of a very narrow deformation region. It should be noted that the power of laser signal 324 and the rate at which region 132-i is scanned under objective lens 316 are typically based on the thickness of the material to undergo laser forming.

At operation 407, the parallelism of optically resonant cavity 128 is re-evaluated. If it has not reached the desired endpoint (e.g., an endpoint indicative of a parallelism equal to or better than 10⁻⁴ radians), operations 406 and 407 are repeated until the desired endpoint is reached. For an optically resonant cavity that is used as an environmental sensor, a representative endpoint is a depth of modulation of the reflected signal that is equal to or greater than 92%. In some embodiments, the parallelism of surfaces 116 and 118 is assessed after each scan, or every few scans of each of regions 132-i. In some cases, suitable parallelism is attained without heat treating every one of regions 132-1 through 132-N. In some cases, additional heat treatment of one or more of regions 132-1 through 132-N is necessary to attain suitable parallelism of surfaces 116 and 118 after the completion of operation 406.

In some embodiments, sensor 100 is a fiber-coupled sensor. As a result, the interrogation of the sensor can be monitored in real time using, for example, a swept-frequency laser system. One skilled in the art will recognize that the optically resonant cavity will provide a meaningful reflected signal only when surfaces 116 and 118 are aligned well enough to give rise to some interference. This affords such embodiments of the present invention advantages, such as obviating the need to move the sample between its laser-forming and interrogation positions.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An optically resonant cavity comprising:
a first surface;
a second surface; and
a support comprising a first material, the support being operative for separating the first surface and second surface by a first separation, wherein the support includes a first region in which the first material is characterized by a first material stress and a second region in which the first material is characterized by a second material stress;
wherein the first separation is characterized by a first parallelism that is based on a difference between the first material stress and the second material stress.

2. The optically resonant cavity of claim 1, wherein the support includes a plurality of tethers that is operative for enabling relative motion between the first surface and second surface.

3. The optically resonant cavity of claim 2, wherein the plurality of tethers is operative for enabling the relative motion based on an environmental stimulus.

4. The optically resonant cavity of claim 1 wherein the first material stress is based on a heat treatment of the first region.

5. The optically resonant cavity of claim 6, wherein the heat treatment comprises operations including:
absorbing energy of a first light signal in the first region; and
cooling the first region.

6. The optically resonant cavity of claim 1, wherein the support includes a third region in which the first material is characterized by a third material stress, and wherein the first separation is characterized by a second parallelism that is based on a difference between the third material stress and at least one of the first material stress and second material stress.

7. The optically resonant cavity of claim 6 wherein the third material stress is based on a heat treatment of the third region.

8. The optically resonant cavity of claim 1 wherein the first parallelism is less than or equal to 10⁻⁴ radians.

9. A method for forming an optically resonant cavity, the method comprising:
providing a first surface;
providing a second surface;
separating the first surface and second surface by a first separation via a support that includes a first region and a second region; and
controlling the material stress of at least one of the first region and second region;
wherein the first separation is characterized by a first parallelism that is based on material stress in each of the first region and second region.

10. The method of claim 9, wherein the material stress in the first region is controlled by heat treating the first region.

11. The method of claim 10, wherein heat treating the first region includes operations comprising:
heating the first region by absorbing energy of a first light signal; and
cooling the first region.

12. The method of claim 11, further comprising scanning the first light signal along a first direction within the first region.

13. The method of claim 9, wherein the material stress in the at least one of the first region and second region is controlled by operations comprising:
receiving a reflected signal from the optically resonant cavity, wherein the reflected signal includes a first spot reflected from the first surface and a second spot reflected from the second surface;
measuring the total power of the reflected signal;
detecting a dynamic component of the reflected signal, wherein the dynamic component is characterized by a modulation depth that is based on a separation between the first spot and second spot.

14. The method of claim 13, wherein the modulation depth is based on optical interference between the first spot and second spot.

15. The method of claim 13, further comprising inducing the dynamic component by inducing relative motion between the first surface and second surface.

16. A method for forming an optically resonant cavity, the method comprising:
providing a first surface;
providing a second surface;
supporting the first surface via a support such that the first surface is separated from the second surface by a first separation; and
controlling a first material stress in a first region of the support, wherein the first material stress controls a first parallelism of the first separation.

17. The method of claim 16, wherein the first material stress is controlled by heat treating a first material in the first region.

18. The method of claim 17, wherein the first material is heat treated by operations comprising:
heating the first material by illuminating it with a first laser signal; and
cooling the first material.

19. The method of claim 16 further comprising determining the first parallelism by operations comprising:
directing a first light signal to the optically resonant cavity;
detecting a second light signal, wherein the second light signal includes a first portion of the first light signal and a second portion of the first light signal, the first portion being reflected from the first surface and the second portion being reflected from the second surface;
detecting a dynamic component in the reflected signal, wherein the dynamic component is based on relative motion between the first surface and second surface; and
determining a modulation depth of the dynamic component, wherein the modulation depth is based on interference between the first portion and the second portion.

20. The method of claim 16, wherein the first material stress in the first region is controlled such that the first parallelism is less than or equal to 10⁻⁴ radians.
